(19) United States
(12) Patent Application Publication
(10) Pub. No.: US 2008/0191157 A1
(43) Pub. Date: Aug. 14, 2008

(54) Modular media control valve

(76) Inventor: Phoung Taylor Nguyen, Richmond, TX (US)

Correspondence Address: Robert C. Curfiss, 19826 Sundance Drive, Humble, TX, 77346-1402, US

(21) Appl. No.: 11/705,252

(22) Filed: Feb. 12, 2007

(51) Int. Cl. F16K 51/00

(52) U.S. Cl. 251/145

(57) ABSTRACT

A media control valve has a valve body having a media inlet and a media outlet and a plunger which is positioned within the valve body. The plunger is connected to a metering control assembly in the bore of the valve body and can be removed without disturbing the control assembly. A sleeve is positioned in the valve body between the valve body and the plunger. The sleeve includes an integral seal for sealing the valve to a flow device such as a base. The valve stem or post for housing the control knob may have metering marks for visually indicating the position of the plunger relative to the sleeve. The control knob on the valve is aligned with the metering marks on the valve body, whereby the valve opening may be calibrated by visual indication of the alignment of the metering marks with the lower edge of the control knob.

### BACKGROUND OF THE INVENTION

1. Field of the Invention

The present invention is related to media control and, more specifically, media control valves used to control the flow of a media into a fluid stream as part of an apparatus for treatment of a surface.

2. Description of the Related Art

A typical media control valve is the pipe side valve shown and described in U.S. Pat. No. 4,322,058, issued to Thompson, et al on Mar. 30, 1982 (the “Thompson Patent”). This valve has been has been widely accepted in applications where the flow of particulate material, such as sand or other abrasive material, from a tank or hopper, is fed into a blast line for propelling the particulate material or media through a nozzle.

As shown in the Thompson Patent, the valve has a unitary plunger which is movable axially with respect to a lateral particulate material inlet between positions closing and opening the inlet. The plunger is moved by rotation on a threaded portion of the plunger through an internally threaded or tapped cap or bonnet opening. The valve body passage through which the plunger is disposed, and the plunger itself, are formed to have abrasion resistant surfaces.

A lateral air pipe base sealed to the valve body receives the abrasive material flowing through the valve for use in blasting operations.

Various improvements to the basic media control valve have been proposed. For example, U.S. Pat. No. 5,407,379 (“the '379 patent”) and U.S. Pat. No. 5,401,205 (“the '205 patent”) disclose a media control valve having a media passage between the media control valve and the conduit. The media passage converges into a slot-shaped outlet in the conduit so as to reduce the perimeter of the outlet placed perpendicular to air flow and consequently reduce turbulence as air passes across the outlet. The media control valve disclosed in the '205 and '379 patents is particularly useful in metering and dispensing sodium bicarbonate media. The '045 patent, discussed previously, also discloses a modification of the original media control valve, including the use of multiple seals around a plunger of the valve with an exhaust therebetween to remove any contaminants that breach the seals.

Despite the various improvements in myriad valve designs for a variety of applications, the valve disclosed in the Thompson patent is to this day a widely accepted valve for blasting operations. As desirable as this valve is, there remains room for improvement, especially with respect to wear reduction, as well as repair and maintenance of the valve.

It is desirable to improve on the various prior art designs by incorporating design changes which facilitate maintenance and repair of the valve. Because of the harsh environment of the valve use, the wear between the plunger and the body of the valve can cause failure of various components which then have to be periodically replaced. As shown in FIGS. 1 and 2 (Prior Art), the typical prior art valve comprises a body 6 having a bore for receiving a plunger 15. A cap 4 also has a central bore for receiving the plunger and a flange for securing the cap to the body by a pair of bolts 3. The control knob 1 is secured to the outer end of the plunger by a roll pin or drive pin 2 which passes through a hole in the knob and a hole 14 provided in the outer end of the plunger. The plunger seal 7, sleeve 8 and gasket 9 are assembled in typical fashion and mounted on the base 10 using the same bolts 3 which hold the cap 4 in assembled relationship with the body 6. The assembled prior art valve is shown in FIG. 2.

In typical use, the primary wear portions of the valve are the plunger portion 15 and the sleeve 8. However, in the prior art valves the entire plunger and knob assembly must be removed and the valve completely disassembled in order to replace the worn plunger. Likewise, the sleeve can only be replaced by disassembling the entire valve. Further, because the bolts 3 pass through the cap, body, and sleeve and into the base, a full body gasket cannot be incorporated in the design.

It is desirable to provide a media control valve permitting more cost effective maintenance by reducing the replacement requirements for those components which are not subject to wear, to provide a more effective body gasket system and to permit easier assembly and disassembly.

### SUMMARY OF THE INVENTION

The subject invention is directed to a media control valve with a valve body having a media inlet and a media outlet and a plunger which is positioned within the valve body. The plunger is connected to a metering control assembly in the bore of the valve body and can be removed without disturbing the control assembly. A sleeve is positioned in the valve body between the valve body and the plunger. The sleeve includes an integral seal for sealing the valve to a flow device such as a base.

In one aspect of the invention, the media control valve includes a valve body having a media inlet and a media outlet, the valve body being adapted to be mounted on a flow device for providing communication between the media outlet and the flow device. A plunger is positioned within the valve body. A sleeve is positioned within the valve body with media inlet opening in the sleeve adapted to receive a particulate media. A metering system is attached to the plunger for controlling the position of the piston within the body and relative to the media opening in the sleeve. The sleeve includes an integral seal adapted to seal connection between the valve body and the flow device.

In another aspect of the invention, the media control valve includes a valve body having a media inlet and a media outlet, the valve body being adapted to be mounted on a flow device for providing communication between the media outlet and the flow device. The plunger is positioned within the valve body. A sleeve is positioned within the valve body with a media inlet opening in the sleeve adapted to receive a particulate media. A metering system is attached to the plunger for controlling the position of the plunger within the body and relative to the media opening in the sleeve, wherein the metering system includes a shaft axially moveable relative to the valve body and the sleeve, and wherein the plunger is removably attached to the shaft. In the preferred embodiment of the invention, metering marks are provided on the outer wall of the post or stem of the valve for permitting accurate adjustment of the knob and plunger as it is turned into and out of the body. In the preferred form, the metering marks are an accurate visual representation of the position of the plunger relative to the sleeve orifice, giving an accurate visual representation of the metered opening in the valve. In the preferred embodiment the bottom edge of the control knob is in communication with a series of metering marks. These marks give a clear, visual indication of the position of the plunger in the valve, corresponding with the position of the bottom edge of the knob as aligned with the marks. Specifically, the control knob on the valve is aligned with the metering marks on the valve body, whereby the valve opening may be calibrated by visual indication of the alignment of the metering marks with the lower edge of the control knob.

It is an important feature of the invention that the media control valve is of a modular design, with the first module including a valve body and a control knob assembly, the second module comprising a plunger adapted to be carried in the valve body and removably mounted on the control knob assembly, and the third module comprising a sleeve adapted to be carried in the body and including an integral seal for sealing the valve body to the flow device when mounted thereon. This facilitates both manufacture and repair of the valve by permitting each of the various modules to be serviced without disturbing the remaining modules. The sleeve is designed such that the valve assembly bolts do not pass through the sleeve. The sleeve further includes an integral gasket for sealing the sleeve, body and base, facilitating assembly and improving the seal integrity of the assembled valve. The metering knob for controlling the position of the plunger is permanently mounted to a threaded metering shaft to which the plunger may be removably mounted.

It is, therefore, an object and feature of the invention to provide a modular media control valve having a valve and sleeve assembly which are easily removed and replaced without requiring the replacement of non-wear components.

It is a further object and feature of the invention to provide a modular media control valve assembly having an integral seal between the valve body and the base to which the valve is mounted.

It is also an object and feature of the invention to eliminate a separate cap from the valve assembly by providing a plunger that can be removed and disassembled from the sleeve end of the valve.

Other objects and features of the invention will be readily apparent from the accompanying drawings and description.

### BRIEF DESCRIPTION OF DRAWINGS

FIG. 1 (PRIOR ART) is an exploded view of a typical prior art media control valve.

FIG. 2 (PRIOR ART) is the cross-section of an assembled prior art media control valve as depicted in FIG. 1.

FIG. 3 is an exploded view of a media control valve in accordance with the subject invention.

FIG. 4 is a longitudinal cross-section of the assembled modular media control valve of FIG. 3, taken along a section line corresponding to the axis of the base to which the valve is mounted.

FIG. 5 is a horizontal cross-section of the assembled modular media control valve of FIG. 3, taken along a section line intercepting the axis of the base.

FIG. 6 is a partial sectional view taken along the line 6-6 of FIG. 5 showing the indexing flat on the sleeve.

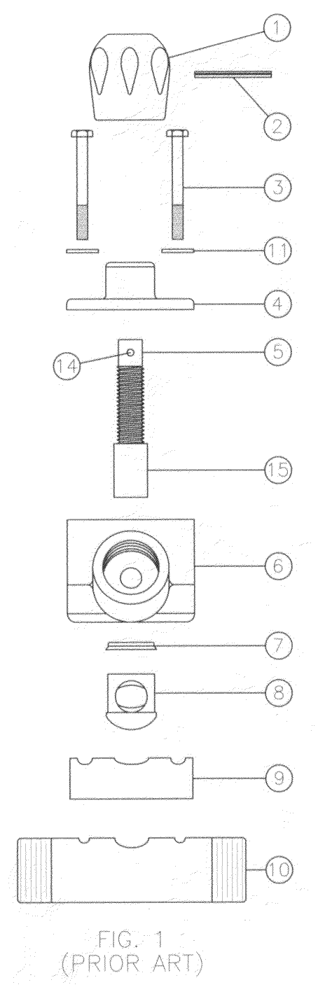

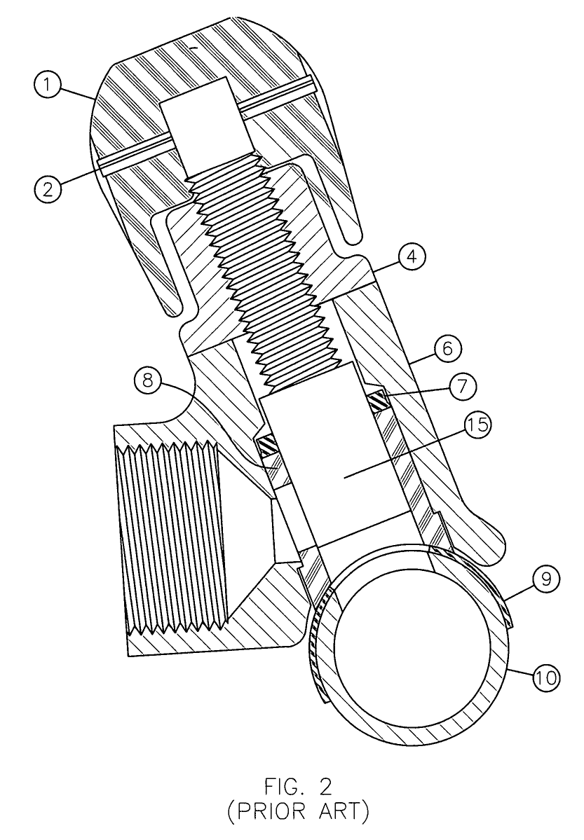

### DETAILED DESCRIPTION OF THE PREFERRED EMBODIMENTS

The present invention is directed to a valve for controlling the flow of a media to a fluid stream, referred to herein as a media control valve. By media, it is meant any material or materials that may be desired to be added to another material or materials. While various solid, fine particulate, blasting media, such as sand, metal shot, and the like, are used by way of example herein, the media that may be supplied by the media control valve of the present invention is not so limited, and may include a wide variety of materials including liquids and gasses as well as solid particles. The subject invention is particularly useful when used in applications containing solid particles of a defined maximum particulate size.

In one embodiment, the media control valve of the present invention includes a valve body having a media inlet and a media outlet. A housing is connected to the valve body. A plunger is positioned within the valve body. A sleeve is mounted in the body and receives the plunger. Typically, the valve, plunger and sleeve assembly are mounted on a base. The media flows through the valve and sleeve, as metered by the plunger, and into the base.

The base is connected to a pressure fluid source, such as compressed or pressurized air, for mixing with the media as it flows through the media control valve and for driving the media/pressure fluid mix through the base.

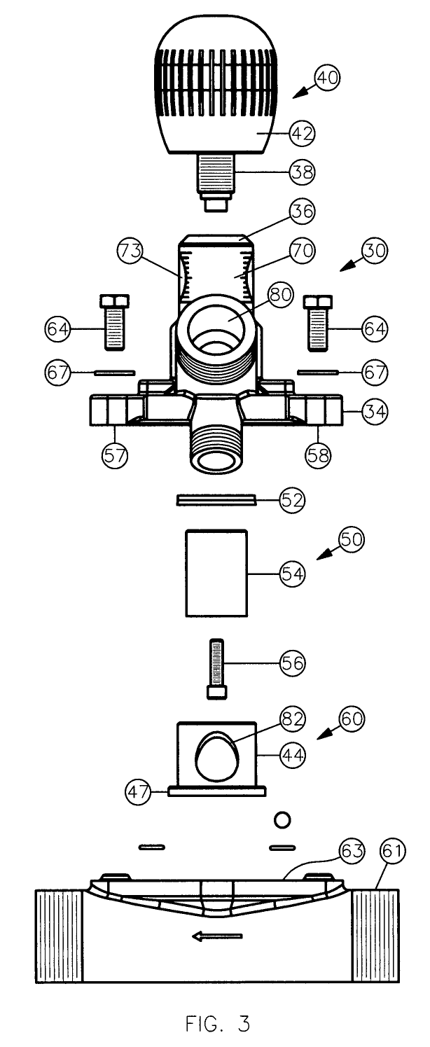

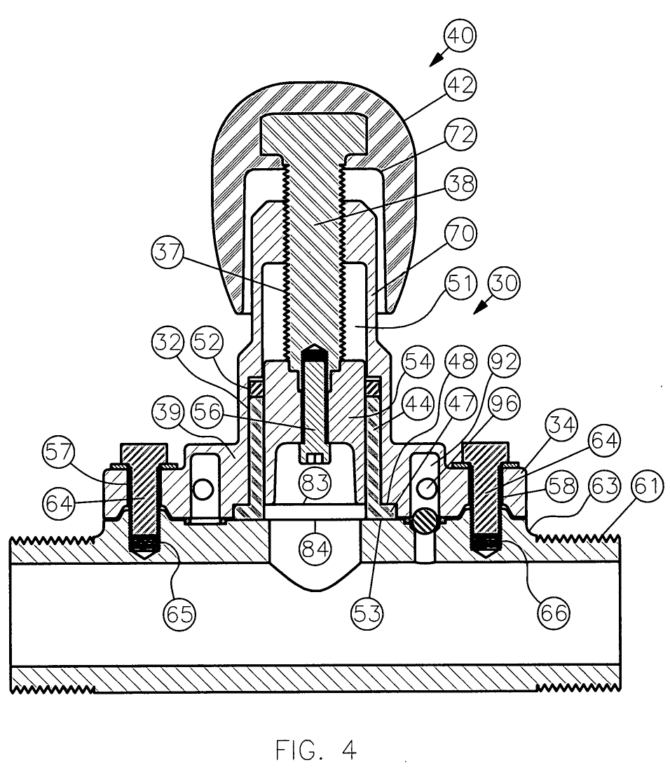

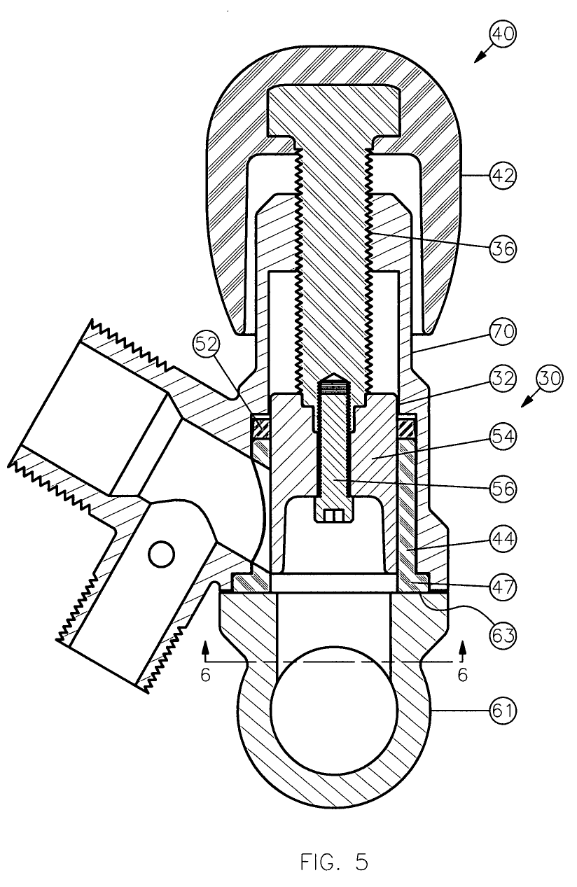

FIG. 3 is an exploded view of the modular media control valve of the subject invention. As there shown, the entire valve assembly is housed in a base or body 30 having a central bore 32 (see FIG. 4), and a mounting flange 34. The upper open end 36 of the bore is tapped to receive the threaded shaft 38 of the knob assembly 40. The modular design of the valve permits three separate modules which can be manufactured, assembled and repaired separately. The fully assembled modules can then be mounted on a typical base mounting flange 63 as will be described.

In the preferred embodiment of the invention, the first module includes the valve body 30 and control knob assembly 40. The knob assembly 40 includes the threaded shaft 38 and the metering knob 42. Typically, the metering knob 42 is permanently secured to the shaft 38 and the threaded shaft is carried in the valve body. The upper post portion 70 of the body is adapted to receive the inner hollow bore 72 of the knob 42, as best seen in FIGS. 3 and 4. Metering marks 73 are provided on the outer wall of the post portion 70 for permitting accurate adjustment of the knob and plunger as it is turned into and out of the body. In the preferred embodiment of the invention, the metering marks are an accurate visual representation of the position of the plunger relative to the sleeve orifice, giving an accurate visual representation of the metered opening in the valve. It is an important feature of the invention that the control knob 42 provides an actual visual indication of the position of the plunger in the valve. In the preferred embodiment, the bottom edge 71 of the control knob is in communication with a series of metering marks 73. These marks give a clear, visual indication of the position of the plunger in the valve, corresponding with the position of the bottom edge of the knob as aligned with the marks. marks with the lower edge of the control knob.

Once assembled, the valve works in typical fashion. The media inlet 80 (FIG. 3) permits the flow of media into the valve and through the media port 82 in the sleeve at the rate controlled by the position of the plunger 54. This is controlled by turning the control knob to the appropriate metering position 73 on the valve post 70. The media flows out of the valve through media outlet port 83 and into the base through base media opening or media inlet port 84 in the mounting flange 63 of base 61. There it is mixed with a pressurized fluid such as pressurized air or the like, and propelled from the base into and through a nozzle, not shown.

The second module 50 comprises the plunger assembly which includes the plunger seal 52, the plunger 54 and the plunger mounting bolt 56.

The third module 60 comprises the sleeve 44 and integral seal 47.

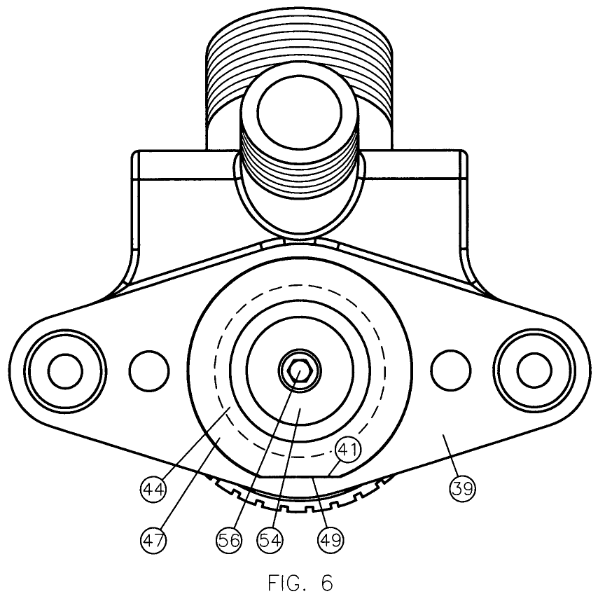

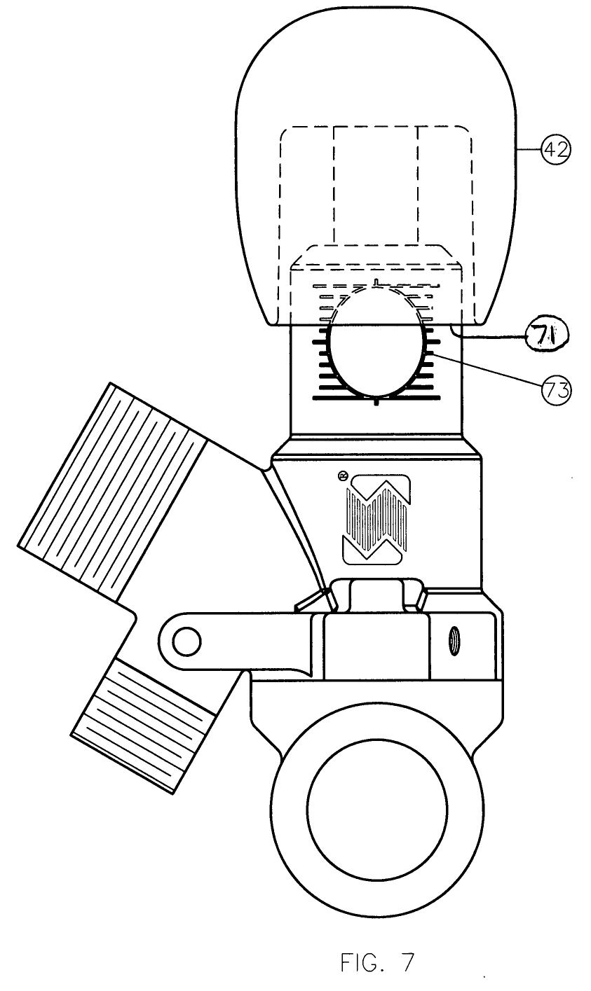

With specific reference to the drawings, it will be noted that the lower end 39 of the body (see FIG. 4) receives the sleeve 44 in an enlarged bore 46. The sleeve 44 fits in the enlarged bore and has an inner diameter which is approximately the same as the inner diameter of the mid-bore zone 51 of the body. The lower end of the body is recessed or stepped at 48 to receive the shoulder 47 of the sleeve. As best shown in FIG. 6, the sleeve 44 includes a flat segment 49 on the shoulder 47 which is mated with a complementary flat surface 41 on the lower end 39 of the valve body. This permits the sleeve to be properly positioned in the valve body with appropriate alignment of the sleeve opening 82 with the valve port 80 (see FIG. 3). This greatly facilitates replacement and repair of the valve. When assembled, the plunger 54 is designed to move axially relative to the sleeve to provide a metered opening for media flow.

The body is typically made of a hard metal material, whereas the sleeve is typically a softer synthetic material, as is well known to those who are skilled in the art. The shoulder 47 on the sleeve is slightly thicker than the depth of the recess 48 such that it extends beyond the lower face 53 of the valve body when assembled. This defines a seal between the body 30 and the base 61 when the valve body and base are assembled.

The plunger seal 52 is received in the body bore between the sleeve and the upper tapped portion 37 of the body bore. The plunger seal is made of a resilient synthetic material. The plunger 54 is placed in the valve body bore and is secured to the knob assembly 40 by the plunger bolt 56, as best seen in FIGS. 4 and 5.

The outer flange 34 of the body includes two mounting holes 57, 58. These mate with tapped bore holes 65, 66, respectively, on the mounting flange 63 provided on the base 61, as best seen in FIGS. 4 and 5. Mounting bolts 64 and spacer washers 67 are used to secure the body to the base. As the body is tightened down, the shoulder 47 on the sleeve 44 is compressed between the lower face 53 of the body and the outer wall of the base flange 63, providing a tight, integral seal between the body and the base. By placing the seal on the shoulder of the sleeve, proper placement of the seal is assured. Also, this assures that the seal is replaced whenever the sleeve is replaced.

The upper post portion 70 of the body is adapted to receive the inner hollow bore 72 of the knob 42, as best seen in FIGS. 4 and 5. Metering marks 73 are provided on the outer wall of the post portion 70 for permitting accurate adjustment of the knob and plunger as it is turned into and out of the body.

Maintenance of the valve assembly is greatly enhanced by the modular design of the preferred embodiment. The entire valve assembly is secured to the base by the mounting bolts 64. When the mounting bolts are removed, the valve body may be removed from the base for exposing the sleeve and the plunger. The sleeve, plunger and plunger seal may then be removed and replaced without further disassembly of the valve. This permits easy replacement of all wear components and minimizes the need to replace non-wear components. Specifically, the plunger seal 52 and sleeve 44 can be removed without further disassembly. The plunger can be removed after loosening plunger bolt 56.

Once assembled, the valve works in typical fashion. The media inlet 80 (FIG. 3) permits the flow of media into the valve and through the media port 82 in the sleeve at the rate controlled by the position of the plunger 54. This is controlled by turning the control knob to the appropriate metering position 73 on the valve post 70. The media flows into the base through base media opening 84 in the mounting flange 63. There it is mixed with a pressurized fluid such as pressurized air or the like, and propelled from the base into a nozzle, not shown.

While certain features and embodiments of the valve assembly of the present invention have been described and shown in detail herein, it should be understood that the invention incorporates all modifications and enhancements within the scope and spirit of the following claims.

What is claimed is:

1. A media control valve, comprising: a valve body having a media inlet and a media outlet, the valve body being adapted to be mounted on a flow device for providing communication between the media outlet and the flow device; a plunger positioned within the valve body; a sleeve positioned within the valve body; a media inlet opening in the sleeve adapted to receive a particulate media; a metering system attached to the plunger for controlling the position of the piston within the body and relative to the media opening in the sleeve, the sleeve further including an integral seal adapted to seal the connection between the valve body and the flow device.

2. The valve of claim 1, wherein the metering system includes a shaft axially moveable relative to the valve body and the sleeve, and wherein the plunger is removably attached to the shaft.

3. The valve of claim 2, wherein the metering system includes a control knob on the shaft and outboard of the valve body, with a calibration surface being provided on the control knob and metering marks on the valve body in communication with the calibration surface for providing a visual indication of the position of the plunger in the valve.

4. The valve of claim 3, wherein the calibration surface is the lower edge of the control knob.

5. The valve of claim 4, wherein the position of the plunger is in a one-to-one correlation with the position of the control knob.

6. The valve of claim 1, wherein the sleeve includes an alignment surface for assuring proper alignment of the sleeve with the valve.

7. The valve of claim 6, wherein the valve body includes a complementary alignment surface adapted for mating with the alignment surface on the sleeve.

8. The valve of claim 7, wherein the respective alignment surfaces are flat segments on the mating walls of the sleeve and the body.

9. The valve of claim 2, wherein the metering system comprises an upper portion in the valve body the upper portion having an internal bore in axial alignment with the media outlet, the internal bore adapted for housing a axially moveable control shaft, wherein the plunger is removably mounted on the shaft for movement therewith relative to the media outlet.

10. The valve of claim 9, wherein the metering system further comprises a control knob mounted on the control shaft and externally of the upper portion for controlling the position of the plunger.

11. The valve of claim 10, wherein the internal bore of the upper portion is tapped and the control shaft is threaded with complementary threads, whereby rotation of the shaft in the bore causes axial movement of the control knob, shaft and plunger relative to the valve body.

12. The valve of claim 10, wherein the outer wall of the upper portion includes calibrating indicia permitting accurate axial positioning of the control knob, shaft and plunger relative to the sleeve.

13. The valve of claim 10, wherein the control knob is permanently secured to the shaft.

14. The valve of claim 10, wherein the plunger is removably mounted to the shaft.

15. The valve of claim 10, wherein the internal bore in the upper portion is smaller than the valve bore housing the sleeve and wherein a plunger seal is located between the sleeve and the upper portion internal bore.

16. The valve of claim 1, the valve body having a recessed flange or step surrounding the media outlet opening and the sleeve having a shoulder adapted to be received in the recess, the shoulder being thicker than the depth of the step, whereby the shoulder is compressed between the valve body and the flow device when the valve is mounted on the flow device.

17. A media control valve comprising: a valve body having a media inlet and a media outlet, the valve body being adapted to be mounted on a flow device for providing communication between the media outlet and the flow device; a plunger positioned within the valve body; a sleeve positioned within the valve body; a media inlet opening in the sleeve adapted to receive a particulate media; a metering system attached to the plunger for controlling the position of the piston within the body and relative to the media opening in the sleeve, wherein the metering system includes a shaft axially moveable relative to the valve body and the sleeve, and wherein the plunger is removably attached to the shaft.

18. The valve of claim 17, the sleeve further including an integral seal adapted to seal the connection between the valve body and the flow device.

19. The valve of claim 18, the valve body having a recessed flange or step surrounding the media outlet opening and the sleeve having a shoulder adapted to be received in the recess, the shoulder being thicker than the depth of the step, whereby the shoulder is compressed between the valve body and the flow device when the valve is mounted on the flow device.

20. The valve of claim 17, wherein the metering system comprises an upper portion in the valve body the upper portion having an internal bore in axial alignment with the media outlet, the internal bore adapted for housing an axially moveable control shaft, wherein the plunger is removably mounted on the shaft for movement therewith relative to the media outlet.

21. The valve of claim 20, wherein the metering system further comprises a control knob mounted on the control shaft and externally of the upper portion for controlling the position of the plunger.

22. The valve of claim 21, wherein the internal bore of the upper portion is tapped and the control shaft is threaded with complementary threads, whereby rotation of the shaft in the bore causes axial movement of the control knob, shaft and plunger relative to the valve body.

23. The valve of claim 22, wherein the outer wall of the upper portion includes calibrating indicia permitting accurate axial positioning of the control knob, shaft and plunger.

24. The valve of claim 21, wherein the control knob is permanently secured to the shaft.

25. The valve of claim 21, wherein the plunger is removably mounted to the shaft.

26. The valve of claim 21, wherein the internal bore in the upper portion is smaller than the valve bore housing the sleeve and wherein a seal is located between the sleeve and the upper portion internal bore.

27. A modular media control valve assembly adapted to be mounted on a flow device, the valve comprising a first module including a valve body and a control knob assembly, a second module comprising a plunger adapted to be carried in the valve body and removably mounted on the control knob assembly, and a third module comprising a sleeve adapted to be carried in the body and including an integral seal for sealing the valve body to the flow device when mounted thereon.

28. The valve of claim 27, the valve body having a media inlet and a media outlet, the valve body being adapted to be mounted on a flow device for providing communication between the media outlet and the flow device, wherein the integral seal in the sleeve extends outwardly of the media outlet and seals the media outlet with the flow device.

29. The valve of claim 27, wherein the control knob assembly of the first module includes an axial control shaft axially moveable relative to the valve body and the sleeve, and wherein the plunger of the second module is removably attached to the shaft.

30. The valve of claim 28, wherein the valve body of the first module includes an upper portion in the valve body, the upper portion having an internal bore in axial alignment with the media outlet, the internal bore adapted for housing the axially moveable control shaft of the first module, wherein the plunger of the second module is removably mounted on the shaft of the first module for movement therewith relative to the media outlet.

31. The valve of claim 30, wherein the first module further comprises a control knob mounted on the control shaft and externally of the upper portion for controlling the position of the plunger.

32. The valve of claim 32, wherein the internal bore of the upper portion is tapped and the control shaft is threaded with complementary threads, whereby rotation of the shaft in the bore causes axial movement of the control knob, shaft and plunger relative to the valve body.

33. The valve of claim 32, wherein the outer wall of the upper portion is marked with calibrating indicia permitting accurate axial positioning of the control knob, shaft and plunger.

34. The valve of claim 33, wherein the control knob is permanently secured to the shaft.

35. The valve of claim 34, wherein the internal bore in the upper portion is smaller than the valve bore housing the sleeve and wherein a seal is located between the sleeve and the upper portion internal bore.
